(19) United States
(12) Patent Application Publication
(10) Pub. No.: US 2025/0222600 A1
(43) Pub. Date: Jul. 10, 2025

(54) ROBOTIC GRIPPER AND CONTROL METHOD

(71) Applicant: COMMISSARIAT A L'ENERGIE ATOMIQUE ET AUX ENERGIES ALTERNATIVES, Paris (FR)

(72) Inventors: Mathieu GROSSARD, Gif-sur-Yvette Cedex (FR); Saifeddine ALOUI, Grenoble (FR); Theo AYRAL, Grenoble (FR)

(21) Appl. No.: 19/011,931

(22) Filed: Jan. 7, 2025

(30) Foreign Application Priority Data
Jan. 10, 2024 (FR) 2400222

(51) Int. Cl. B25J 15/10; B25J 9/16; B25J 13/08

(52) U.S. Cl. CPC B25J 15/103; B25J 9/1612; B25J 9/163; B25J 13/083

(57) ABSTRACT

A robotic gripper including one or more fingers and at least one actuator for acting on the fingers in order to grip an object, the gripper including at least one sensor sensitive to a relative movement between the object manipulated by the gripper and the latter, this sensor delivering an output signal, a control system configured to execute at least one machine-learning algorithm trained to deliver, based on the one or more output signals generated by the one or more sensors, at least one slippage-detection score representative of the confidence of the algorithm in the presence of slippage, and to transmit control data to the actuators controlling the one or more fingers, the control data being generated so as to relate the strength of the forces applied by the one or more fingers to said score.

### TECHNICAL FIELD

The present invention relates to the field of robotics and in particular to the field of manipulation of objects by grippers, in particular pluri-digital grippers.

### PRIOR ART

Robotic grippers are equipped to grasp objects and move them. They are widely used on assembly lines or for handling operations. During its movement, however, it is not uncommon for the object to become unbalanced and slip. This is because external disturbances may exceed the forces able to be transmitted by the points of contact between the fingers of the gripper and the object. Adhesion between the object and the fingers is then lost and the object, subjected to external forces, begins to slip. The weight of the object may also quite simply be underestimated, the gravitational forces exerted being greater than the forces transmitted by the gripper.

There are known methods for countering this slippage effect with grippers comprising a gripping jaw. In particular, certain methods consist in detecting and reacting to slippage by increasing the gripping force of the robotic jaw on the object. The gripping force must also be controlled so as to minimize the required power and to prevent any damage to the object.

In the case of a robotic jaw, because of symmetry, the fingers exert opposing forces that cancel each other out and allow the object to be stabilized. When the gripper comprises fingers that are not symmetrically arranged, as in the case of an “artificial hand”, the increase in grip may induce an undesired movement of the object.

In the case of grippers comprising more than 3 fingers, it is known to seek to determine a GRASP matrix, which is a representation of the points of contact between the object and the gripper, allowing the forces and torques applied in the reference frame of the gripper to be projected into the reference frame of the object. Based on this matrix, it is sought to solve an optimization problem consisting in determining the minimum forces to be applied to stop slippage while allowing the desired movement of the object, and while respecting the dynamic limits of the gripper.

Chapter 5 “Fundamentals of Grasping, Course CS 237B: Principles of Robot Autonomy II”, Stanford University, J. Bohg, M. Pavone, and D. Sadigh, teaches that optimizing forces under handling and friction constraints requires information on the forces in 6 dimensions at each point of contact between the object and the gripper. This tends to make implementation complex and costly.

Patent application EP4048480 describes a robotic arm arranged to allow slippage to be detected using a plurality of sensors intended to deliver multimodal data. The use of multimodal data is intended to allow data to be merged for slippage detection.

Patent application US 2020/019864 describes machine-learning methods intended to collect information during robotic manipulation of objects so as to automate implementation of such manipulation.

The article “A Novel Incipient Slip Degree Evaluation Method and Its Application in Adaptative Control of Grasping Force”, Ruomin Sui et al., 1545-5955, 2023 IEEE describes a method for controlling the gripping force of an experimental robotic jaw with two parallel fingers, based on knowledge of the distribution of the contact forces obtained using optical sensors and on computation of the coefficient of friction.

The article “Spectro-Temporal Recurrent Neural Network for Robotic Slip Detection with Piezoelectric Tactile Sensor”, Théo Ayral et al., 2023 IEEE/ASME International Conference on Advanced Intelligent Mechatronics (AIM), Jun. 28-30, 2023, Seattle, Washington, USA describes a method for detecting slippage using a recurrent neural network (RNN) that delivers a binary output: presence of slippage or absence of slippage.

The article “Detecting and Controlling Slip through Estimation and Control of the Sliding Velocity”, Marco Costanzo et al., Appl. Sci. 2023, 13, 921 describes a method for detecting slippage and adapting grip based on estimation of a sliding velocity and friction state between an object and a gripper.

The article “Force estimation and slip detection/classification for grip control using a biomimetic tactile sensor”, Su Zhe et al. 2015 IEEE-RAS 15th International Conference on Humanoid Robots (Humanoids), Seoul, Korea (South), 2015, pp. 297-303 describes a gripper robot equipped with “BioTacs” sensors configured to deliver data that is then analyzed to estimate the forces applied at various points of the gripper. This article also describes a method allowing binary classification of the type (rotary or linear) of slippage detected.

Patent application US2021/122039A1 describes a “pick and place” robot capable of detecting slippage of the moved object by determining the forces applied at various points of the end effector of the robot, which may therefore take the form of a gripper.

### DISCLOSURE OF THE INVENTION

There is a need to overcome the drawbacks of the prior art and to improve manipulation of an object by a robotic gripper, in particular a gripper comprising more than 2 fingers, so as to tailor grip as best as possible, to react quickly to the appearance of slippage, to avoid damaging the object by gripping it too tightly (while limiting power consumption), and to improve existing grip-control methods, in particular to make them accessible and transferable.

It would also still be advantageous to reduce the complexity of robotic grippers, in particular robotic grippers comprising more than 2 fingers.

The invention aims to meet all or some of these needs.

### SUMMARY OF THE INVENTION

### Gripper

The invention relates, according to a first of its aspects, to a robotic gripper comprising:
one or more fingers,
at least one actuator for acting on the one or more fingers in order to grip an object, the gripper comprising at least one sensor sensitive to a relative movement between the object manipulated by the gripper and the latter, this sensor delivering an output signal,
a control system configured to execute at least one machine-learning algorithm trained to deliver, based on the one or more output signals generated by the one or more sensors, at least one slippage-detection score representative of the confidence of the algorithm in the presence of slippage, and to transmit control data to the actuators controlling the one or more fingers, the control data being generated so as to relate the strength of the forces applied by the one or more fingers to said score, and in particular in such a way as to increase the gripping forces on the object as the slippage-detection score increases.

Preferably, the control system is arranged to iteratively and incrementally adjust the strength of the forces exerted by the gripper on the object, the value of the increment being variable and dependent on the value of said slippage-detection score in each iteration.

The invention makes it possible to adapt a gripper's hold on the object more rapidly and without requiring complex information on forces and friction. In particular, only one or more slippage-detecting sensors need be used, in addition to any further sensors allowing the location of the points of contact and information on the shape or configuration of the gripper to be determined, in order to make it possible to locate and orient the points of contact in the same frame, and to determine the orientation of the normal forces. Knowledge of the strength of the forces is not necessary. The actuators may thus be controlled without computing a coefficient of friction and/or without measuring a contact force.

The invention is applicable to gripping any type of object.

Because it is not necessary to measure forces, the invention potentially allows the complexity of the sensors to be decreased, this in particular allowing the size of the gripper to be reduced. Manipulation of smaller objects is thus facilitated.

The invention also allows power consumption to be limited, by limiting the gripping forces to just what is needed to hold the object. Specifically, when the gripper is relatively “sure” that slippage is occurring, the gripping forces may be rapidly increased to stop the slippage. In case of uncertainty in the detection of slippage, the gripper does not tighten its grip or tightens it slightly while watching progress. Thus, if there was in fact no slippage, an unnecessary increase in gripping force, to the detriment of power consumption, is avoided. If there was in fact slippage, in particular gravity-related slippage, then it will tend to accelerate, leading to a decrease in detection uncertainty, and the gripper will be able to react correctly.

Adjusting the forces applied by the gripper, depending on the slippage-detection score, thus makes it possible to react in a measured way to any slippage and to more easily preserve the integrity of the manipulated object.

The machine-learning algorithm may comprise at least one neural network, in particular an RNN or TCN, arranged to classify at least one input signal generated by at least one of said sensors into two classes respectively corresponding to the presence of slippage and to the absence of slippage, the network comprising a last layer with two output neurons taking normalized values, a function making these normalized values dependent on the scores of each class, this normalization function preferably being a softmax function.

The neural network may receive as input data corresponding to successive measurement time windows.

The one or more sensors may comprise at least one vibration detector, in particular a piezoelectric vibration detector.

The control system may be arranged to perform a spectral analysis of the signal delivered by these one or more sensors, for example through application of a fast Fourier transform, in order to generate a spectrogram, and thus determine the frequency content of the signal. This spectral analysis may be carried out iteratively, so as to determine its variation as a function of time, and the neural network may be trained to classify a time segment of the spectrogram.

The control system may be arranged to deliver a set of local slippage-detection scores for various sensors, and to generate the slippage-detection score based on these local detection scores, in particular by taking the maximum of the local detection scores, the median of the local detection scores, the mean of the local detection scores, the third quartile of the local detection scores or the mode of the local detection scores, the detection score preferably corresponding to the maximum of the local detection scores.

At least one finger, preferably a plurality of fingers, and more preferably all the fingers, comprise a plurality of phalanges, each of the fingers comprising at least one slippage-sensitive sensor, in particular a piezoelectric sensor. The gripper may comprise at least two fingers, preferably at least 3 fingers, or even at least 5 fingers, each finger preferably comprising a plurality of phalanges. The gripper may also comprise sensors configured to detect the points of contact, in particular piezoresistive sensors.

The control system may be arranged to acquire a distribution of the points of contact between the manipulated object and the fingers of the gripper and to compute ratios defining proportionality relationships to be maintained between internal gripping forces applied to the points of contact, the relationships being computed based on the distribution of the points of contact and on the orientation of the fingers in a frame associated with the gripper, the internal forces being forces applied to the points of contact that balance one another.

Computing the relationships between the strengths of the forces at the various points of contact may comprise determining a GRASP matrix representative of the forces applied by the gripper to the object at the various points of contact, and computing a basis of the kernel of the matrix, the GRASP matrix being determined by means of the location of the points of contact and of the orientation of the fingers in a frame associated with the gripper. The forces applied to the object may be modified by a factor proportional to the slippage-detection score while respecting the relationships between the strengths applied at the various points of contact as determined by the GRASP matrix.

The tactile sensors are preferably arranged so as to allow detection over a large area for each sensor. This large area may cover the entire finger or only the operational area of the gripper intended to make contact with the manipulated object, when it is a question of the sensors of points of contact.

The slippage-detecting sensors and the sensors of points of contact may be independent. A single slippage-detecting sensor may be sufficient for the entire gripper.

The control system may comprise one or more processors, one or more microcontrollers, one or more personal computers, one or more automata.

The control system may be at least partially embedded in the gripper.

### Method

Another subject of the invention, according to another of its aspects, is a method for controlling a gripper manipulating an object, in particular a gripper according to the invention as defined above, the gripper comprising:
one or more fingers,
at least one actuator for acting on the one or more fingers in order to grip the object,
at least one sensor sensitive to a relative movement between the object manipulated by the gripper and the latter, this sensor delivering an output signal, the method comprising:
   generating at least one slippage-detection score using at least one machine-learning algorithm trained to deliver, based on the one or more output signals generated by the one or more sensors, said score, the latter being representative of the confidence of the algorithm in the presence of slippage, and
controlling the one or more actuators controlling the one or more fingers so as to relate the strength of the forces applied by the one or more fingers to said score, in particular in such a way as to increase the gripping forces on the object as the slippage-detection score increases.

Such a method makes it possible to dispense with estimation and modeling of friction between the object and the gripper.

The strength of the forces exerted by the gripper on the object may be adjusted iteratively and incrementally, the value of the increment being variable and dependent on the value of said slippage-detection score in each iteration.

Such iterations in particular make it possible to minimize the forces required to stop slippage, and thus to avoid any damage to the object and needless waste of power.

In examples of implementation of the control method, the strength adjustment may comprise comparing the slippage-detection score with at least one threshold value or reference scale, the adjustment being determined relative to this comparison. For example, when the slippage-detection score is less than or equal to a threshold value, no adjustment is made, and similarly when the slippage-detection score is greater than or equal to a threshold value, no adjustment is made.

An acquisition of at least one signal representative of a negligible relative motion is thus not systematically taken into account. This advantageously makes it possible to avoid continual adjustment of the forces applied by the gripper about a force that would be optimal.

The machine-learning algorithm may comprise at least one neural network, in particular an RNN or TCN, arranged to classify at least one input signal generated by at least one of said sensors into two classes respectively corresponding to the presence of slippage and to the absence of slippage, the network comprising a last layer with two output neurons taking normalized values, a function making these normalized values dependent on the scores of each class, this normalization function preferably being a softmax function.

The one or more sensors may comprise at least one vibration detector, in particular a piezoelectric vibration detector, and the method may comprise a spectral analysis of the signal in order to generate a spectrogram. The neural network may be trained to classify a time segment of the spectrogram.

A set of local slippage-detection scores may be generated for various sensors, and the slippage-detection score may be computed based on these local detection scores, in particular by taking the maximum of the local detection scores, the median of the local detection scores, the mean of the local detection scores, the third quartile of the local detection scores or the mode of the local detection scores, the detection score preferably corresponding to the maximum of the local detection scores.

The internal forces and manipulation forces may be decoupled. Internal forces correspond to the forces applied to the points of contact that balance one another. The gripping forces F_{c} applied by the gripper to the manipulated object may be written: F_{c}=Fₘ+F₀, where Fₘ corresponds to the manipulation forces and F₀ to the internal forces.

The strength relationships preferably take into account only the internal forces.

A distribution of the points of contact between the manipulated object and the fingers of the gripper may thus be acquired, and ratios defining proportionality relationships to be maintained between internal gripping forces applied to the points of contact may be computed, the relationships being computed based on the distribution of the points of contact and on the orientation of the fingers in a frame associated with the gripper, the internal forces being forces applied to the points of contact that balance one another.

Computing the relationships between the strengths of the forces at the various points of contact may comprise determining a GRASP matrix representative of the forces applied by the gripper to the object at the various points of contact, and computing a basis of the kernel of the matrix, f₀=(x₁|i∈[1; N]), N being the number of points of contact between the gripper and the manipulated object, the GRASP matrix being determined by means of the location of the points of contact and of the orientation of the fingers in a frame associated with the gripper. The forces applied to the object may be modified by a factor proportional to the slippage-detection score while respecting the relationships between the strengths applied at the various points of contact as determined by the GRASP matrix.

Preferably, the chosen basis does not comprise negative values, corresponding to attractive forces (suction forces for example).

Heuristic methods may be employed to select a basis. Such methods make it possible to select a relevant basis, in particular one compatible with the physical constraints of configuration and control of the gripper.

Determining strength relationships amounts to finding coefficients xᵢ, solving the equation:

$$G . \vec{{f}_{0}} = \vec{0} , \\ {f}_{0} = ( {x}_{i} \vert i ∈ [ 1 ; N ] ) \qquad [ Math 1 ]$$

Since the gripping forces are in the kernel of the GRASP matrix, they do not generate any movement of the object.

$$G . ( \vec{{f}_{m}} + \vec{{f}_{0}} ) = G . \vec{{f}_{m}} \qquad [ Math 2 ]$$

The matrix G contains at least the location of the points of contact and the orientation of the basis associated with the point of contact, and the model used to describe the nature of the contact (number of components of the forces, friction model). The GRASP matrix G may be determined based on the location of the points of contact and on the orientation of the associated frames.

The GRASP matrix takes into account the normal forces at the points of contact, and optionally tangential forces and moments. These elements may or may not be shown, depending on the gripper's ability to measure and control these forces. Implementation of the method of the invention does not require tangential forces and moments to be measured and controlled. In examples of implementations, the strength relationships take into account only normal components of the internal forces. In particular, a GRASP matrix may be used in “frictionless” mode to determine the strength relationships between normal forces only, allowing control of slippage to be simplified. Computing these strength relationships makes it possible to reduce the complexity of the sensors required for the robotic gripper to operate, if necessary.

Maintaining these strength relationships between the internal forces makes it possible to ensure the balance of the manipulated object. Moreover, by decoupling the internal forces from the manipulation forces, only the question of the balance of the grip of the manipulated object is taken into account, the manipulation being able to be carried out in parallel. This decoupling simplifies adjustment of the forces and reduces the risk of appearance of unexpected motion.

In particular, in addition to the location, information on the orientation of the normal contact forces between the object and the gripper may be associated with each point of contact, in particular by analysing the shape and configuration of the gripper.

The orientations may be computed based on the locations of the points of contact and on the configuration of the gripper, and in particular on the relative positions of the fingers of the gripper, on the positions of the phalanges when the fingers are formed of phalanges, and on the position of the gripper relative to the object.

The strength relationships to be respected between the forces may be computed iteratively in parallel with the steps of the control method intended to react to slippage.

### Computer Program Product

The invention also relates to a computer program product, in particular stored on a medium or in a memory, comprising code instructions that, when the program is implemented by the system for controlling the robotic gripper according to the invention, cause the latter to implement the control method according to the invention.

### BRIEF DESCRIPTION OF THE DRAWINGS

The invention will possibly be better understood on reading the following detailed description of non-limiting examples of implementation thereof, and on examining the appended drawing, in which:

FIG. 1 partially and schematically illustrates one example of a robotic gripper according to the invention,

FIG. 2 schematically shows determination of a point of contact between the gripper and the object,

FIG. 3 illustrates one example of implementation of a control method and of computation of the strength relationships,

FIG. 4 shows determination of the distribution of the points of contact around an object held by a gripper comprising 3 fingers, and

FIG. 5 illustrates one example of iterative adjustment of the internal forces of the gripper over time.

In the rest of the description, elements which are identical or have analogous functions are designated by the same reference sign. Their description is not repeated with reference to each of the figures, only the main differences between the embodiments being mentioned.

### DETAILED DESCRIPTION

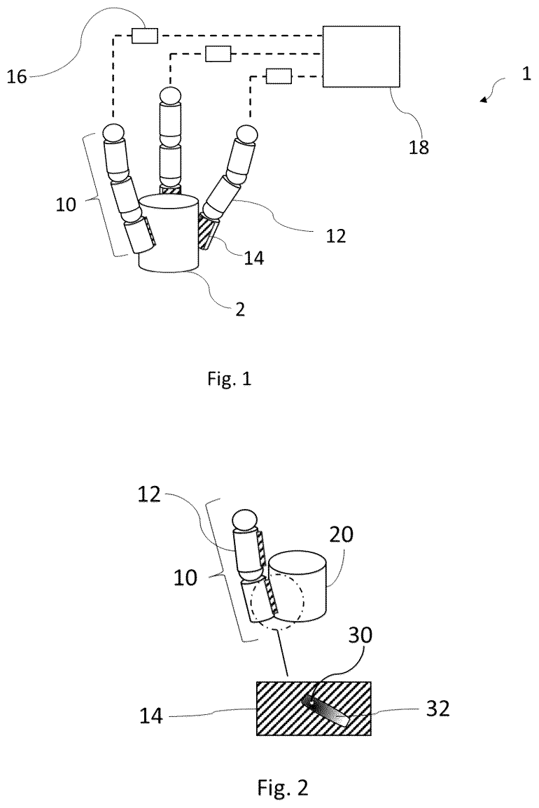

FIG. 1 illustrates one example of a pluri-digital robotic gripper 1. The gripper is shown gripping an object 20, which may be any object.

The robotic gripper 1 comprises a plurality of fingers 10, for example three in number, as illustrated.

The fingers 10 may comprise phalanges 12, as illustrated.

Each finger comprises at least one tactile sensor 14.

In preferred examples of embodiment, each phalange 12 of each finger 10 comprises at least one tactile sensor 14, as shown in FIG. 2.

The gripper 1 also comprises actuators 16 arranged to actuate the fingers and to allow the object 20 to be manipulated.

The actuators 16 are connected to a control system 18 that controls them in particular depending on the motion that they must transmit to the object.

The control system may be implemented with any suitable computing means, and for example comprises one or more processors that execute code instructions allowing the signals of the sensors to be processed and the actuators to be controlled, depending on how the object is to be manipulated, as programmed by a user, and the actuators to be automatically controlled so that the object is gripped with sufficient force to prevent slippage of the grasped object.

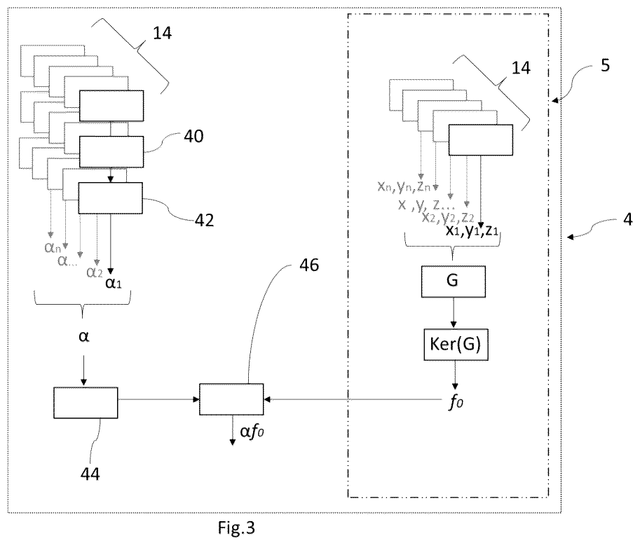

The strength relationships to be maintained between the forces may be determined iteratively by implementing the computing method 5 illustrated in FIG. 3.

The control of the actuators to avoid slippage may be carried out iteratively by implementing the control method 4 also illustrated in this figure.

These two methods may be executed in parallel or consecutively.

The control system 18 may in particular, based on signals transmitted by the sensors 14, determine on the one hand the presence of points of contact 30 between the fingers of the gripper and the object, and on the other hand generate slippage-related information.

As illustrated in FIG. 2, the sensors may be arranged so as to allow detection of contact over a large area. In particular, the contact between the sensor of a finger and the object is not necessarily reduced to a point but may be a contact area 32. Depending on the signals acquired by the sensor, the control system is able to determine a representative point of contact 30 based on these contact areas 32.

The sensor 14 may comprise a pressure sensor, and the point of contact may correspond to the point of highest pressure in the area, the point of contact for example being the centroid of the contact area 32.

The computing method 5 comprises a step of locating points of contact based on signals acquired by the sensors 14 of the gripper and determining a distribution of these points of contact in a global frame [(x₁, y₁, z₁), (x₂, y₂, z₂), . . . , (xₙ, yₙ, zₙ)].

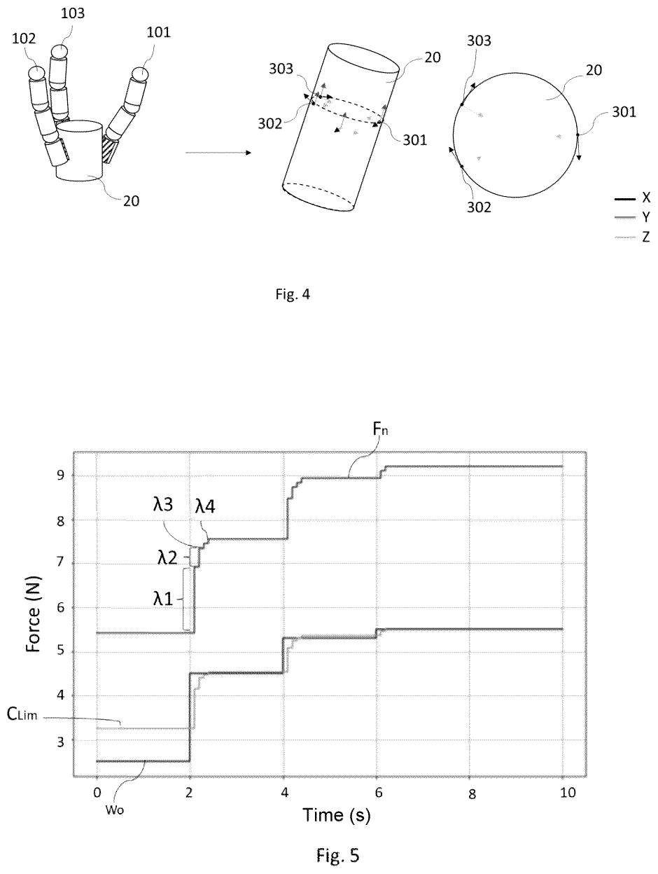

FIG. 4 schematically shows an object 20 and the points of contact 301, 302, 303 with the fingers 101, 102, 103 of the gripper.

The control system 18 may be configured so as to allow detection of the distribution of the points of contact 301, 302, 303 around the object 20, in a global frame (X,Y,Z).

The distribution in the global frame (X,Y,Z) of a point of contact 30 may be determined based on a local position of the point of contact with respect to the sensor 14 and on the configuration of the robotic gripper.

The strength relationships to be maintained between the forces applied to the various points of contact allowing the object 20 to be held may be computed based on the distribution of the points of contact in the global frame, for example by determining a basis f₀ of the kernel, Ker(G), of a matrix G constructed based on the distribution of the points of contact.

Preferably, only internal forces are considered, or in other words the matrix G is constructed assuming decoupling between the internal forces and the manipulation forces, which are the forces applied by the gripper to the manipulated object.

In the example of FIG. 4, it may be estimated that the points of contact 301, 302, 303 are distributed around the object 20, at the same height. In a global frame, the point of contact 301 may be defined to be at an angle θ₃₀₁=0, the point of contact 302 to be at an angle θ₃₀₂=−5π/6 and the point of contact 303 to be at an angle θ₃₀₃=5π/6.

Assuming decoupling between the internal forces and manipulation forces and assuming the friction forces of the internal forces to be zero, the matrix G of the example of FIG. 4 may take the following form:

$$G = [ \begin{matrix}sin θ & - sin θ & 0 \\ - cos θ & - cos θ & - 1 \\ 0 & 0 & 0 \\ 0 & 0 & 0 \\ 0 & 0 & 0 \\ 0 & 0 & 0\end{matrix} ] \qquad [ Math 2 ]$$

with θ=θ₃₀₃=−θ₃₀₂=5π/6

A basis of the kernel of G may be:

$${f}_{0} = [ \begin{matrix}\frac{- 0.5}{cos ( \frac{5 π}{6} )} \\ \frac{- 0.5}{cos ( \frac{5 π}{6} )} \\ 1\end{matrix} ] \approx [ \begin{matrix}0.577 \\ 0.577 \\ 1\end{matrix} ] \qquad [ Math 3 ]$$

The strength relationships to be maintained between the forces applied to the various points of contact therefore correspond here to [0.577; 0.577, 1]. In other words, for an increase in the internal force applied to the point of contact 301 of a, the increase in the internal force applied to the points of contact 302 and 303 will be 0.577*a.

Obviously, this example is given by way of illustration and is non-limiting. In particular, (tangential) friction forces are, if necessary, taken into consideration in the construction of the matrix G, in particular when the gripper allows them to be controlled.

These relationships may be determined by the control system 18 and condition the commands transmitted to the actuators 16, in respect of how the gripper holds the object, i.e. irrespective of the forces applied to make the object move through space.

The control system 18 is arranged so as to allow implementation of an iterative control method 4 comprising, in each iteration, a step of generating a slippage-detection score rating detection of slippage between the manipulated object and the gripper, and a step of adjusting the forces applied by the gripper to the object so as to stop any slippage, this adjustment comprising an increase in the force applied to the object that is proportional to the slippage-detection score.

For example, the sensors 14 comprise vibration sensors, in particular piezoelectric sensors, that react to vibrations induced by slippage. The vibration sensor may be the one described in the article “Spectro-Temporal Recurrent Neural Network for Robotic Slip Detection with Piezoelectric Tactile Sensor”, Ayral et al., 2023 IEEE/ASME International Conference on Advanced Intelligent Mechatronics (AIM), Jun. 28-30, 2023, Seattle, Washington, USA, in section II page 574, this article being incorporated herein by reference.

A fast Fourier transform (FFT) 40 may be applied to the signals of the sensors 14 so as to generate a spectrogram allowing subsequent processing to be concentrated on certain frequencies representative of slippage and to remove actuator-related noise, as described in the article “Spectro-Temporal Recurrent Neural Network for Robotic Slip Detection with Piezoelectric Tactile Sensor”.

The power spectral density (PSD) may thus be computed based on the signals delivered by the piezoelectric detectors, after subtraction of the mean, in time windows, of sampled values, to provide successive spectrograms that serve as input data for a previously trained machine-learning algorithm 42 that may be employed to determine the slippage-detection score.

The machine-learning algorithm may comprise at least one neural network, particularly a recurrent neural network (RNN).

The machine-learning algorithm may correspond to the one described in the article “Spectro-Temporal Recurrent Neural Network for Robotic Slip Detection with Piezoelectric Tactile Sensor”, Ayral et al., 2023 IEEE/ASME International Conference on Advanced Intelligent Mechatronics (AIM), Jun. 28-30, 2023, Seattle, Washington, USA, modified by the addition of a last layer of neurons normalized with a softmax function that delivers as output two normalized scores, one a of which is a normalized and bounded value between 0 and 1 corresponding to the level of confidence in the presence of slippage, the highest value 1 corresponding to a higher confidence in the presence of actual slippage than the value 0.

The neural network may have the architecture described in section IV) part B 1) page 575 of the above article “Spectro-Temporal Recurrent Neural Network for Robotic Slip Detection with Piezoelectric Tactile Sensor” and comprise a stack of 4 GRU units as described in the publication K. Cho, B van Merrienboer, D Bahdanau, and Y Bengio, “On the properties of neural machine translation: Encoder-decoder approaches” 2014 https://arxiv.org/abs.1409.1259. The network described in the article “Spectro-Temporal Recurrent Neural Network for Robotic Slip Detection with Piezoelectric Tactile Sensor” produces a 32-channel representation of each time increment (“sequence to sequence”), and the outputs are independently classified by a fully connected linear classification layer.

Training may have been carried out for each slippage-sensitive sensor as described in 2) of the same section, by simultaneously training the classification layer and the RNN from end to end, with training data that may be generated automatically as described in section III of the article.

It is thus possible to determine in parallel, using a plurality of instances of the machine-learning algorithm, local slippage-detection scores (α₁, α₂, . . . , αₙ) for each of the slippage sensors of the gripper, and the maximum value of the local scores may be taken as slippage-detection score α. In particular, for each slippage sensor, one instance of the algorithm is implemented.

Alternatively, a single instance of the machine-learning algorithm may receive as input a concatenation of the sensor signals so as to determine as output a global value α.

A comparator 44 may compare, in each iteration, the slippage-detection score α with a threshold value beyond which the score α is taken into account as representative of the presence of slippage of the object with respect to the gripper.

Preferably, the adjustment takes into account the distribution of the points of contact around the object, through application of the method for computing strength relationships described above.

A force increase factor or an increment may be determined in each iteration based on the score α, while preserving the relationships between the strengths of the forces to be exerted by the gripper on the object at the various points of contact. The adjustment may thus comprise an increase in the forces applied by the gripper to the object proportional to α.

Alternatively, the increase may be determined by comparing the score α with threshold values. For example, if α is less than a threshold value V₀, then no adjustment is made, if a is in the interval]V₀; V₁] then the adjustment is an increase of β₁*f₀; . . . , if α is in the interval]Vₘ₋₁; 1] then the adjustment is an increase of αₘ*f₀, with β₁ . . . constants.

In one particular embodiment, when the score α is greater than a threshold value, the adjustment consists in increasing the internal forces by a predetermined value. The forces at the various points of contact are increased by this predetermined value modulated by the relationships between the strengths of the forces to be preserved between the various points of contact.

FIG. 5 shows one example of curves of variation in the normal forces applied by a gripper to an object over time. These curves are compared to the weight of the object Wₒ and to the friction forces C_{Lim} between the object and the gripper allowing said object to be gripped by the gripper.

It is possible to see 3 moments when slippage of the object begins, at 2 s, 4 s and 6 s.

The curve C_{Lim} corresponds to the friction force.

In the example of FIG. 5, a plurality of iterations of the slippage control method are implemented, the iteration value being variable δ1, δ2, δ3, δ4, and depending on the score α, in order to stop the detected slippage.

Thus, in the example in FIG. 5, the adjustment is gradual and depends on the score α estimated in each iteration.

The curve Fₙ corresponds to the sum of the strengths of the normal forces applied at the various points of contact between the object and the gripper.

The invention is not limited to the described examples.

It is possible to use sensors other than piezoelectric sensors as slippage-sensitive sensors, and sensors other than piezoresistive sensors to provide information on the location of the points of contact; for example, vision sensors may be used to provide information on the points of contact.

The sensors may thus be chosen from any type of capacitive sensors and/or optical tactile sensors such as GelSight® or FingerVision®.

Since the method according to the invention does not require knowledge of the forces at the points of contact, it is possible to use any kind of sensors making it possible to obtain signals based on which a movement may be detected and making it possible to locate points of contact.

The sensors may form an array of unitary sensors.

The determination of strength relationships may take into account, in addition to normal forces, friction forces. However, it is preferable not to take them into account. Taking into account friction forces improves accuracy, but complicates the computing and force-controlling steps, which are constrained by the capabilities of the gripper.

The control system may operate asynchronously at each point of contact.

A neural network of the TCN type may be used in the machine-learning algorithm.

1. A robotic gripper comprising:
at least two fingers,
at least one actuator for acting on the fingers in order to grip an object, the robotic gripper comprising at least one sensor sensitive to a relative movement between the object manipulated by the robotic gripper and the latter, this sensor delivering an output signal,
a control system configured to execute at least one machine-learning algorithm trained to deliver, based on the one or more output signals generated by the one or more sensors, at least one slippage-detection score representative of the confidence of the algorithm in the presence of slippage, and to transmit control data to the actuators controlling the fingers, the control data being generated so as to relate the strength of the forces applied by the fingers to said score, the control system being arranged to acquire a distribution of the points of contact between the manipulated object and the fingers of the robotic gripper and to compute ratios defining strength relationships to be maintained between internal gripping forces applied to the points of contact, the relationships being computed based on the distribution of the points of contact and on the orientation of the fingers in a frame associated with the robotic gripper, the internal forces being forces applied to the points of contact that balance one another.

2. The robotic gripper as claimed in claim 1, the control system being arranged to iteratively and incrementally adjust the strength of the forces exerted by the robotic gripper on the object, the value of the increment being variable and dependent on the value of said slippage-detection score in each iteration.

3. The gripper as claimed in claim 1, the machine-learning algorithm comprising at least one neural network arranged to classify at least one input signal generated by at least one of said sensors into two classes respectively corresponding to the presence of slippage and to the absence of slippage, the network comprising a last layer with two output neurons taking normalized values and a function making these normalized values dependent on the scores of each class.

4. The gripper as claimed in claim 3, the one or more sensors comprising at least one vibration detector, the control system being arranged to perform a spectral analysis of the signal in order to generate a spectrogram, and the neural network being trained to classify a time segment of the spectrogram.

5. The gripper as claimed in claim 1, the control system being arranged to deliver a set of local slippage-detection scores for various sensors, and to generate the slippage-detection score based on these local detection scores.

6. The gripper as claimed in claim 5, the slippage-detection score being generated by taking the maximum of the local detection scores, the median of the local detection scores, the mean of the local detection scores, the third quartile of the local detection scores or the mode of the local detection scores.

7. The gripper as claimed in claim 1, wherein at least one finger comprises a plurality of phalanges, each of the fingers comprising at least one slippage-sensitive sensor.

8. The robotic gripper as claimed in claim 1, comprising sensors configured to detect the points of contact.

9. The gripper as claimed in claim 1, the actuators being controlled without computing a coefficient of friction and/or without measuring a contact force.

10. The gripper as claimed in claim 1, comprising at least 3 fingers, or even at least 5 fingers, each finger comprising a plurality of phalanges, each finger comprising at least one slippage-sensitive sensor.

11. The gripper as claimed in claim 1, wherein computing the relationships between the strengths of the forces at the various points of contact comprises determining a GRASP matrix representative of the forces applied by the gripper to the object at the various points of contact, and computing a basis of the kernel of the matrix, the GRASP matrix being determined by means of the location of the points of contact and of the orientation of the fingers in a frame associated with the gripper.

12. The gripper as claimed in claim 11, the forces applied to the object being modified by a factor proportional to the slippage-detection score while respecting the relationships between the strengths applied at the various points of contact as determined by the GRASP matrix.

13. A method for controlling a gripper manipulating an object, as defined in claim 1, the gripper comprising:
one or more fingers,
at least one actuator for acting on the fingers in order to grip the object,
at least one sensor sensitive to a relative movement between the object manipulated by the gripper and the latter, this sensor delivering an output signal, the method comprising:
generating at least one slippage-detection score using at least one machine-learning algorithm trained to deliver, based on the one or more output signals generated by the one or more sensors, said score, the latter being representative of the confidence of the algorithm in the presence of slippage,
controlling the one or more actuators controlling the fingers so as to relate the strength of the forces applied by the fingers to said score,
acquiring a distribution of the points of contact between the manipulated object and the fingers of the gripper, and
computing ratios defining strength relationships to be maintained between internal gripping forces applied to the points of contact, the relationships being computed based on the distribution of the points of contact and on the orientation of the fingers in a frame associated with the gripper, the internal forces being forces applied to the points of contact that balance one another.

14. The method as claimed in claim 13, wherein the strength of the forces exerted by the gripper on the object is adjusted iteratively and incrementally, the value of the increment being variable and dependent on the value of said slippage-detection score in each iteration.

15. The method as claimed in claim 13, the machine-learning algorithm comprising at least one neural network arranged to classify at least one input signal generated by at least one of said sensors into two classes respectively corresponding to the presence of slippage and to the absence of slippage, the network comprising a last layer with two output neurons taking normalized values and a function making these normalized values dependent on the scores of each class.

16. The method as claimed in claim 15, the one or more sensors comprising at least one vibration detector, the method comprising a spectral analysis of the signal in order to determine the frequency content of the signal and its variation as a function of time, and the neural network being trained to classify a time segment of the spectrogram.

17. The method as claimed in claim 13, wherein a set of local slippage-detection scores is generated for various sensors, and the slippage-detection score is computed based on these local detection scores.

18. The method as claimed in claim 13, wherein computing the relationships between the strengths of the forces at the various points of contact comprises determining a GRASP matrix representative of the forces applied by the gripper to the object at the various points of contact, and computing a basis of the kernel of the matrix, the GRASP matrix being determined by means of the location of the points of contact and of the orientation of the fingers in a frame associated with the gripper.

19. The method as claimed in claim 18, the forces applied to the object being modified by a factor proportional to the slippage-detection score while respecting the relationships between the strengths applied at the various points of contact as determined by the GRASP matrix.

20. A computer program comprising code instructions that, when the program is executed on one or more processors of a system for controlling a robotic gripper as claimed in claim 1, cause the latter to implement the control method as claimed in claim 13.
